(19) United States
(12) Patent Application Publication
(10) Pub. No.: US 2018/0242191 A1
(43) Pub. Date: Aug. 23, 2018

(54) METHODS AND DEVICES IN A COMMUNICATION NETWORK

(71) Applicant: Huawei Technologies Co., Ltd., Shenzhen (CN)

(72) Inventors: Henrik LUNDQVIST, Kista (SE); Tao CAI, Kista (SE)

(21) Appl. No.: 15/956,484

(22) Filed: Apr. 18, 2018

Related U.S. Application Data
(63) Continuation of application No. PCT/EP2015/074170, filed on Oct. 19, 2015.

(51) Int. Cl. H04W 28/02; H04L 12/801; H04W 72/12

(52) U.S. Cl. CPC H04W 28/0289; H04L 47/127; H04W 88/16; H04W 28/0236; H04W 28/0268; H04W 72/1236

(57) ABSTRACT

A system, a network device, a sending device, and corresponding methods for a communication network are disclosed. The system comprises a processor configured to: receive at least one predicted congestion level C_{pred} and at least one predicted radio channel quality Q_{pred} associated with a data flow; and determine at least one of a transmission rate T_{R} or a data flow path T_{P} for transmission of the data flow based on the predicted congestion level C_{pred} and the predicted radio channel quality Q_{pred}.

### CROSS-REFERENCE TO RELATED APPLICATIONS

This application is a continuation of International Application No. PCT/EP2015/074170, filed on Oct. 19, 2015, the disclosure of which is incorporated herein by reference in its entirety.

### FIELD OF INVENTION

Implementations described herein relate generally to a scheduler, a network device and a sending device, and to methods for a communication network.

### BACKGROUND OF INVENTION

In communication networks, such as e.g. cellular networks, data that shall be sent to a receiving device, such as e.g. a mobile device, may be sequentially buffered at multiple places along the communication path from a sending device to the receiving device. This often results in a significant delay for data packets being delivered to the receiving device. To minimize such an end-to-end delay, conventional solutions often use content delivery networks (CDN) to optimize the communication path between the sending device and the receiving device. CDNs use servers that are located close to the receiving device, for example on the premises of an access network operator, to send the data over a short flow path to the receiver.

For mobile receiving devices/users, however, varying transmission rates and the mobility of the devices/users make it challenging to deliver the packets to the right transmission points in time while avoiding unnecessary delay, in particular if high network resource utilization is required. Since the mobile receiving devices/users move around in the communication network and since the transmission rates to the receiving mobile devices/users can vary, the data to be sent to a receiving device is buffered at multiple places along the communication path from the sending device to the receiving device. Conventional solutions therefore often result in relatively high packet latencies in mobile networks, due to buffering in network nodes along the communication path.

### SUMMARY OF INVENTION

It is therefore an object to solve at least some of the above mentioned disadvantages and to improve the performance in a communication network.

The above mentioned disadvantages are solved by the subject matter of the independent claims. Further advantageous implementation forms of the present disclosure can be found in the dependent claims.

According to one aspect, the object is achieved by a scheduler for a communication network, the scheduler comprising a processor configured to:

receive at least one predicted congestion level C_{pred} and at least one predicted radio channel quality Q_{pred} associated with a data flow; and

determine at least one of a transmission rate T_{R} or a data flow path T_{P} for transmission of the data flow based on the predicted congestion level C_{pred} and the predicted radio channel quality Q_{pred}.

In one embodiment, the scheduler being configured to schedule transmission from a sending device is informed about predicted radio channel qualities and congestion levels for at least parts of the data flow path. The predictions can e.g. be made by a network device or by network nodes, e.g. a base station/eNB, and can be provided to the scheduler by a mechanism which is appropriate for the specific used transport protocol. This also allows the scheduler to apply policies for transmission that are appropriate for the application creating the data flow. This is particularly beneficial for schedulers that are handling many flows to different user/receiver devices, and have the possibility to schedule transmissions to the user/receiver devices that have the best channel conditions at a given transmission time while maintaining a minimum required end-to-end quality of service for all flows.

By usage of the scheduler, in one embodiment, the feedback about the predicted channel conditions for different users can be utilized such that the scheduler can distribute its quota of resources to the users that have the highest utility from the resources at any given time. Hereby, a mutually beneficial cooperation between an access network provider and a service provider can be implemented based on information sharing. A satisfying end-to-end quality of service can hereby be provided in an efficient way.

According to some embodiments, the scheduler is located/implemented in the sending device. The scheduler then provides an improvement of the end-to-end performance for the end system, since full knowledge of the application requirements, e.g. the instantaneous fill level of a receiver buffer, can be used as basis for determination of at least one of a transmission rate T_{R} or a data flow path T_{P} to be used for the data flow.

The scheduler being implemented in the sending device makes it possible for the access network and the end systems, including sending devices and receiving devices, to cooperate by providing the predicted information from the access network to the sending devices, such that the respective parties can handle the task each of them are in the best position to handle. The access network can provide feedback which reflects both predicted congestion and radio channel quality. By providing the scheduler with relevant predicted channel information, it also becomes possible for a scheduler to adapt the sending rate of the sending device in an efficient way, which also reduces the need for buffering in the network. This also offers a possibility for the network operators to provide additional information to external parties, which adds value by enabling better service delivery.

By usage of the scheduler, a multi user diversity gain can be achieved already at the traffic source, i.e. at the sending device which sends the data flow, whereby an optimization between performance and congestion can be achieved.

The end systems, i.e. the sending devices and the receiving devices, have the best knowledge of the delay requirements and also have control of the sending rate. The end systems also have more possibilities to adapt the sending rate for example by using different fidelity levels for the transmitted data, and to control the size of receiver buffers to use the network efficiently in the presence of rate variations.

The proposed scheduler overcomes a possible feedback delay problem by use of predicted information about the channel conditions in the traffic control. The future channel is here predicted by the access network, or based on information from the access network. Since the access network has a more complete view of the traffic demand and traffic load, the access network is in a better position to make the prediction than the end system. Hence, a solution that provides predicted channel information from the access network to the scheduler of the sending devices of the end system has a potential to improve the end-to-end performance in the communication network.

In an example scenario, a content delivery network or service provider, like e.g. a streaming video service provider, would have an application server (AS) co-located with the access network, which could be a mobile operator network. If the scheduler scheduling the sending device, here being an application server, can be provided with predictions about the channel quality and local congestion from the access network, the scheduler can take into account the network conditions when it schedules traffic to the receiver devices of the end system. Since it is likely that the server has many users in an area, it can make a positive difference for the total system performance if the scheduler schedules the transmissions to when receiving devices have good channel conditions. In particular, when such sender side multi-user scheduling is combined with traffic management policies that give incentive for the service providers to use the access network efficiently, this has a great potential for improving an overall network utility. Such policies could be based on congestion pricing and/or congestion volume limits. In conventional solution networks, it is instead natural for a content delivery network/service provider to deliver traffic in the way that minimize the server cost, without taking into account the access network conditions. By providing the predicted channel condition information, the access network offers an added value to the service provider while aligning the goals of both the access network and the end system.

In one embodiment, the processor is further configured to determine any of the transmission rate T_{R} and the data flow path T_{P} for a specified prediction time period, the prediction time period being specified by a subscription for the data flow.

Since the prediction time periods are specified in the information subscriptions, it is possible to select prediction time periods that are suitable for each specific data flow. The frequency of changes in the transmission rate and transmission path can therefore be data flow specific. The transmission rate T_{R} and the data flow path T_{P} are determined for time periods that correspond to the time periods of the prediction time periods in order to make best use of the predicted information. According to some embodiments, the transmission rate T_{R} and the data flow path T_{P} may be determined for multiple periods that correspond approximately and/or at least partially to the prediction time periods.

In another embodiment, the processor is further configured to send a subscription request S_{SR} to a network device, the subscription request S_{SR} including a request to send the predicted congestion level C_{pred} and the predicted radio channel quality Q_{pred} associated to the data flow to the scheduler for a specified prediction time period.

This has an advantage in that the predicted information is only provided to the schedulers that can make use of it, which minimizes the problem of backward compatibility. This also makes it possible to provide the predicted congestion level C_{pred} and the predicted radio channel quality Q_{pred} as a value adding information to external parties, such as e.g. service providers. The prediction time period refers to a time interval for which the congestion level C_{pred} and the predicted radio channel quality Q_{pred} are predicted.

In yet another embodiment, the processor is further configured to receive predicted congestion levels C_{pred} and predicted radio channel quality values Q_{pred} for at least two prediction time periods.

This allows the scheduler to determine rate and path adaptation based on how the channel is expected to behave during multiple future prediction time periods. For example, the scheduler may then select transmission data rates that are proportional to the channel conditions, i.e. depending on the channel quality and the congestion, during each one of the prediction time periods, and may achieve an average rate that corresponds to an application requirement.

According to another aspect, the object is achieved by a network device for a communication network, the network device comprising a processor configured to:

identify a data flow for at least one receiving device;

determine at least one predicted congestion level Cpred and at least one predicted radio channel quality Qpred associated with the data flow; and

send the predicted congestion level C_{pred} and the predicted radio channel quality Q_{pred} to at least one scheduler.

In one embodiment, a network device being located/implemented in the access network has better possibility to collect information about the access network state than a sender device or receiver device. In particular, the network device can have access to network management information which is not exposed to external nodes outside the access network. A network operator can therefore use internal information to predict congestion levels and radio channel qualities, and can then expose only these metrics that are useful for controlling the transmission rate and data flow path for the data flows.

The feedback about the predicted channel conditions for different users is sent to the scheduler. The scheduler can utilise these predicted channel conditions by distributing its quota of resources to the users that have the highest utility from the resources at any given time. Hereby, a mutually beneficial cooperation between an access network provider and a service provider can be implemented based on information sharing. End-to-end quality of service can be provided in an efficient way.

In one embodiment, the processor is further configured to receive a subscription request S_{SR} associated with the data flow, the subscription request S_{SR} including a request to send the predicted congestion level C_{pred} and the predicted radio channel quality Q_{pred} associated to the data flow to the scheduler for a specified prediction time period.

This has an advantage in that the predicted information is only provided to the schedulers that can make use of it. Since the prediction time period is specified in the information subscription, it is possible to select prediction time periods that are suitable for each specific data flow.

In another embodiment, the processor is further configured to:

receive a subscription request S_{SR} associated with the data flow, the subscription request S_{SR} including a flow identification information; and

identify the data flow and at least one node which can provide information for the prediction of the congestion level C_{pred} and the radio channel quality Q_{pred} for the data flow based on the received flow identification information.

To include the flow identification information (flow ID) in the subscription request S_{SR} has an advantage in that the identification of the data flow at the network device is simplified. The flow identity is also used to find the network nodes that have predictive information for the data flow, or have information that can be used to predict the congestion level and radio channel quality for the data flow.

In yet another aspect, the processor is further configured to compute and send the predicted congestion level C_{pred} and the predicted radio channel quality Q_{pred} for another prediction time period, the other prediction time period having a length being different from the prediction time period specified in the subscription request S_{SR}.

The other prediction time period is according to an embodiment chosen such that it is possible to compute the predicted congestion level C_{pred} and the predicted radio channel quality Q_{pred} for that period.

The information subscribing entity, e.g. the scheduler or the sending device, may have a preference for the prediction periods that are most suitable for its rate and path control algorithms. However, the network device may not have information that makes it possible to compute predictions for such time periods with reasonable accuracy. The feasible prediction time periods depend on factors such as mobile node velocity, the physical environment such as other moving objects and mobile devices, dynamics of the traffic load within the network, availability of radio maps, prediction algorithms and/or processing power. When the network device cannot provide information for the preferred time periods, it will instead provide information for time periods that are as similar as possible, e.g. being of most similar length, to the requested ones. Hereby, the scheduling device can adapt its control algorithms based on the available information. The subscribing entity will also be informed about the length of the prediction time periods.

In still another aspect, the processor is further configured to:

receive a transmission rate determined by at least one radio interface scheduler to be used for the data flow over a radio interface; and

predict at least one of the congestion level C_{pred} or the radio channel quality Q_{pred} based also on the transmission rate determined by at least one radio interface scheduler.

Hereby, an efficient prediction of at least one of the congestion level C_{pred} or the radio channel quality Q_{pred} is transmission rate achieved, since the prediction is also based on a transmission rate estimate for the scheduling which is actually going to be used for the radio interface. Since the scheduled transmission rate for the radio interface is not completely random, but is actually under the control of the radio interface scheduler, this can improve the prediction of the congestion level C_{pred} and the radio channel quality Q_{pred}. According to some embodiments, the predicted scheduled radio transmission rate can be directly provided to the information subscriber. However, an advantage of providing the predicted congestion level C_{pred} and the predicted radio channel quality Q_{pred} to the information subscriber instead is that the control algorithms in the scheduler and sending device can be designed to always work with congestion level and channel quality information, regardless of whether it is provided as subscribed information from a network device or is estimated from the sender device itself. Providing the transmission rate information from the radio interface scheduler gives additional information regarding a part of the data flow path. This additional information may be useful for some scheduler and sending device control algorithms.

In another embodiment, the processor is further configured to:

receive at least one of a measured congestion level Cₘₑₐₛ or a measured quality level Qₘₑₐₛ from at least one network node along a data flow path T_{P} for the data flow; and

predict at least one of the congestion level C_{pred} or the radio channel quality Q_{pred} based also on at least one of the measured congestion level Cₘₑₐₛ or the measured quality level Qₘₑₐₛ.

Hereby, an efficient prediction of at least one of the congestion level C_{pred} or the radio channel quality Q_{pred} is achieved, since the prediction is also based on of the congestion level Cₘₑₐₛ and/or the quality level Qₘₑₐₛ. The measurements are here provided by the network nodes forwarding the data in the data flow. The prediction is thus based on actual channel conditions for the data flow that can be combined with other input, such as e.g. the user location and the load in additional network nodes. This makes the prediction efficient and reliable.

In yet another embodiment, the processor is further configured to only send the predicted congestion level C_{pred} and the predicted radio channel quality Q_{pred} if the at least one scheduler is authenticated as subscribing to a service delivering the predicted congestion level C_{pred} and the predicted radio channel quality Q_{pred}.

This has an advantage in that the network operator can sell information subscriptions as a value added service. The information about the predicted congestion level C_{pred} and the predicted radio channel quality Q_{pred} helps external service providers to use the network more efficiently and provide more reliable quality of service to the customers. For the network operator, it can be a way to increase revenues from over-the-top services by providing such an added value.

Also, the delivery of the predicted congestion level C_{pred} and the predicted radio channel quality Q_{pred} is efficiently controlled, whereby signalling in the communication network is minimized, since no predicted congestion levels C_{pred} or predicted radio channel qualities Q_{pred} are sent without a proper authorization.

According to yet another aspect, the object is achieved by a sending device for a communication network, the sending device comprising a processor configured to:

send a subscription request S_{SR}, the subscription request S_{SR} including a request for a predicted congestion level C_{pred} and a predicted radio channel quality Q_{pred} associated to a data flow;

receive at least one of a transmission rate T_{R} or a data flow path T_{P} for transmission of the data flow; and

adapt transmission of the data flow based on the at least one of a transmission rate T_{R} or a data flow path T_{P}.

The sending device according to the third aspect is the first entity to know when a new flow is starting. It is therefore in a good position to send the information subscription request to the access network. The sending device can also adapt its transmission rate to the rates determined by the scheduler in a way that has the least effect on the quality experienced by the user/receiving device. This depends on the specific application causing the transmission. For example, the rate of a video flow may be reduced by the sending device by avoiding sending some quality enhancement layers, by slowing down the playout rate and/or by letting the playout buffer level decrease. The sending device may also have the possibility to send data belonging to the same application level flow over multiple paths, for example using a multipath transport protocol. In this case, the sending device can receive information about the transmission rates T_{R} for multiple data flow paths and may split the transmission accordingly based on the information. According to an embodiment, the subscription request S_{SR}, includes a specified prediction time period for which the predicted congestion level C_{pred} and the predicted radio channel quality Q_{pred} should be sent.

In one embodiment, the processor is further configured to determine a length of a prediction time period based on at least one of latency requirements or rate adaptability for an application.

The sending device has the best information about the application dynamics, and the possibilities for the application to adapt its transmission rate when the channel changes. For example, background file downloads can use long prediction time periods and can postpone transmission for extended periods. Live video transmissions, however, cannot postpone data transmission, and have to change the transmission rate during shorter time periods. Even in the case of video transmission, the length of the useful prediction time period depends on the mechanism that is used for the transmission rate adaptation, and also depends on the encoding scheme and encoding parameters of the video data.

According to still another aspect, the object is achieved by a method for a communication network, the method comprising:

receiving at least one predicted congestion level C_{pred} and at least one predicted radio channel quality Q_{pred} associated with a data flow;

determining at least one of a transmission rate T_{R} or a data flow path T_{P} to be used for the data flow based on the predicted congestion level C_{pred} and the predicted radio channel quality Q_{pred}.

The proposed method has an advantage in that a scheduler being configured to schedule transmission from a sending device is informed about predicted radio channel qualities and congestion levels for at least parts of the data flow path. The feedback about the predicted channel conditions can be utilised such that the scheduler can distribute its quota of resources to the users that have the highest utility from the resources at any given time. Hereby, a mutually beneficial cooperation between an access network provider and a service provider can be implemented based on information sharing. A satisfying end-to-end quality of service can hereby be provided in an efficient way.

In one embodiment, the method further comprising determining any of the transmission rate T_{R} and the data flow path T_{P} for a specified prediction time period, the prediction time period being specified by a subscription for the data flow.

It is hereby possible to select prediction time periods that are suitable for each specific data flow. The frequency of changes in the transmission rate and transmission path can therefore be data flow specific.

In another embodiment, the method further comprising sending a subscription request S_{SR} to a network device, the subscription request S_{SR} including a request to send the predicted congestion level C_{pred} and the predicted radio channel quality Q_{pred} associated to the data flow to the scheduler for a specified prediction time period.

Hereby, the predicted information is only provided to the schedulers that can make use of it, which minimizes the problem of backward compatibility. This also makes it possible to provide the predicted congestion level C_{pred} and the predicted radio channel quality Q_{pred} as a value adding information to external parties, such as e.g. service providers.

In still another embodiment, the method further comprising receiving predicted congestion levels C_{pred} and predicted radio channel quality values Q_{pred} for at least two prediction time periods.

This allows the scheduler to determine rate and path adaptation based on how the channel is expected to behave during multiple future prediction time periods. For example, the scheduler may then select transmission data rates that are proportional to the channel conditions during each one of the prediction time periods, and may achieve an average rate that corresponds to an application requirement.

According to another aspect, the object is achieved by a method for a communication network, the method comprising:

identifying a data flow for at least one receiving device;

determining at least one predicted congestion level C_{pred} and at least one predicted radio channel quality Q_{pred} associated with the data flow; and

sending the predicted congestion level C_{pred} and the predicted radio channel quality Q_{pred} to at least one scheduler.

A network device located/implemented in the access network has better possibility to collect information about the access network state than a sender device or receiver device. According to the method, a network operator can use internal information to predict congestion levels and radio channel qualities, and can then externally expose only these metrics that are useful for controlling the transmission rate and data flow path for the data flows.

In one embodiment, the method further comprising receiving a subscription request S_{SR} associated with the data flow, the subscription request S_{SR} including a request to send the predicted congestion level C_{pred} and the predicted radio channel quality Q_{pred} associated to the data flow to the scheduler for a specified prediction time period.

This has an advantage in that the predicted information is only provided to the schedulers that can make use of it. Since the prediction time period is specified in the information subscription, it is possible to select prediction time periods that are suitable for each specific data flow.

In another embodiment, the method further comprising:

receiving a subscription request S_{SR} associated with the data flow, the subscription request S_{SR} including a flow identification information; and

identifying the data flow and at least one node which can provide information for the prediction of the congestion level C_{pred} and the radio channel quality Q_{pred} for the data flow based on the received flow identification information.

To include the flow identification information (flow ID) in the subscription request S_{SR} has an advantage in that the identification of the data flow at the network device is simplified. The flow identification is also useful for requesting the prediction information from other nodes. This may include to request routing information, for example from a flow controller node or from a mobility management entity, to determine which nodes can provide the prediction information. The flow identification is also used when an information request is sent to the nodes that shall provide information, as is described in detail below.

In yet another embodiment, the method further comprising computing and sending the predicted congestion level C_{pred} and the predicted radio channel quality Q_{pred} for another prediction time period, the other prediction time period having a length being different from the prediction time period specified in the subscription request S_{SR}.

According to the method, when the network device cannot provide information for the preferred time periods, it will instead provide information for time periods that are as similar as possible to the requested ones. Hereby, the scheduling device can adapt its control algorithms based on the available information.

In still another embodiment, the method further comprising:

receiving a transmission rate determined by at least one radio interface scheduler to be used for the data flow over a radio interface; and

predicting at least one of the congestion level C_{pred} or the radio channel quality Q_{pred} based also on the transmission rate determined by at least one radio interface scheduler.

Hereby, an efficient prediction of at least one of the congestion level C_{pred} or the radio channel quality Q_{pred} is transmission rate achieved, since the prediction is also based on a transmission rate estimate for the scheduling which is actually going to be used for the radio interface.

In another embodiment, the method further comprising:

receiving at least one of a measured congestion level Cₘₑₐₛ or a measured quality level Qₘₑₐₛ from at least one network node along a data flow path T_{P} for the data flow; and

predicting at least one of the congestion level C_{pred} or the radio channel quality Q_{pred} based also on at least one of the measured congestion level Cₘₑₐₛ or the measured quality level Qₘₑₐₛ.

Hereby, an efficient prediction of at least one of the congestion level C_{pred} or the radio channel quality Q_{pred} is achieved, since the prediction is also based on measurements of the congestion level Cₘₑₐₛ and/or the quality level Qₘₑₐₛ. The measurements are here provided by the network nodes forwarding the data in the data flow. The prediction is thus based on actual channel conditions for the data flow which can be combined with other input, such as e.g. the user location and the load in additional network nodes, which makes the prediction efficient and reliable.

In yet another embodiment, the method further comprising only sending the predicted congestion level C_{pred} and the predicted radio channel quality Q_{pred} if the at least one scheduler is authenticated as subscribing to a service delivering the predicted congestion level C_{pred} and the predicted radio channel quality Q_{pred}.

This has an advantage in that the network operator can sell information subscriptions as a value added service. The information about the predicted congestion level C_{pred} and the predicted radio channel quality Q_{pred} helps external service providers to use the network more efficiently and provide more reliable quality of service to the customers. For the network operator, it can be a way to increase revenues from over-the-top services by providing such an added value.

According to another aspect, the object is achieved by a method for a communication network, the method comprising: sending a subscription request S_{SR}, the subscription request S_{SR} including a request for a predicted congestion level C_{pred} and a predicted radio channel quality Q_{pred} associated to a data flow:

receiving at least one of a transmission rate T_{R} or a data flow path T_{P} for transmission of the data flow; and

adapting transmission of the data flow based on the at least one of a transmission rate T_{R} or a data flow path T_{P}.

According to the method, the sending device can adapt its transmission rate to the rates determined by the scheduler in a way that has the least effect on the quality experienced by the user/receiving device. For example, the rate of a video flow may be reduced by the sending device by avoiding to send some quality enhancement layers, by slowing down the playout rate and/or by letting the playout buffer level decrease. The sending device may also have the possibility to send data belonging to the same application level flow over multiple paths, for example using a multipath transport protocol. In this case, the sending device can receive information about the transmission rates T_{R} for multiple data flow paths and may split the transmission accordingly based on the information.

In one embodiment, the method further comprising determining a length of the prediction time period based on at least one of latency requirements or rate adaptability for an application.

The sending device has information about the application dynamics, and the possibilities for the application to adapt its transmission rate when the channel changes. Therefore, the sending device is well equipped to determine a suitable length of the prediction time period.

According to yet another aspect, the object is achieved by a computer program, characterized in code, which when run by a processor causes said processor to execute any above and below described method. Further, the implementations described also relate to a computer program product comprising a computer readable medium and said mentioned computer program, wherein said computer program is included in the computer readable medium, and comprises of one or more from the group: read-only memory (ROM), programmable ROM (PROM), erasable PROM (EPROM), flash memory, electrically EPROM (EEPROM), and hard disk drive.

Further applications and advantages of the described aspects and implementation forms will be apparent from the following detailed description in conjunction with the accompanying drawings. It is to be understood, however, that the drawings are designed solely for purposes of illustration and not as a definition of the limits of the herein disclosed embodiments, for which reference is to be made to the appended claims. Further, the drawings are not necessarily drawn to scale and, unless otherwise indicated, they are merely intended to conceptually illustrate the structures and procedures described herein.

An “or” in this description and the corresponding claims is to be understood as a mathematical OR which covers “and” and “or”, and is not to be understand as an XOR (exclusive OR).

Also, the term “and/or” comprises any and all combinations of one or more of the associated listed items. In addition, the singular forms “a”, “an” and “the” are to be interpreted as “at least one”, thus also possibly comprising a plurality of entities of the same kind, unless expressly stated otherwise. It will be further understood that the terms “includes”, “comprises”, “including” and/or “comprising”, specifies the presence of stated features, actions, integers, steps, operations, elements, and/or components, but do not preclude the presence or addition of one or more other features, actions, integers, steps, operations, elements, components, and/or groups thereof.

### BRIEF DESCRIPTION OF THE DRAWINGS

Embodiments of the invention are described in more detail with reference to attached drawings illustrating examples of embodiments of the invention in which:

FIG. 1 is a block diagram schematically illustrating a scheduler according to some embodiments.

FIG. 2 is a flow chart diagram illustrating a method for a communication network according to some embodiments.

FIG. 3 is a block diagram illustrating network device according to an embodiment.

FIG. 4 is a flow chart diagram illustrating a method for a communication network according to some embodiments.

FIG. 5 is a block diagram illustrating sending device according to an embodiment.

FIG. 6 is a flow chart diagram illustrating a method for a communication network according to some embodiments.

FIGS. 7a-b are block diagrams schematically illustrating a communication network according to some embodiments.

FIG. 8 is a signaling flow chart diagram illustrating a method for a communication network according to some embodiments.

FIG. 9 illustrates a network information message.

FIG. 10 illustrates prediction information elements.

FIG. 11 illustrates a subscription request message.

FIG. 12 illustrates a subscription request response message.

### DETAILED DESCRIPTION OF INVENTION

As stated above, conventional solutions often cause relatively high packet latencies in mobile networks, since buffering of data is made in network nodes along the communication path. The data transmission rate to be used can here for some conventional solutions be predicted based on observations of browsing history and application interaction history, in order to download data and cache it on a mobile device in advance. In particular, this would allow the data to be downloaded while the device is connected to a non-cellular network.

Some conventional transport protocols use predictions of the data throughput to adapt the transmission rate. However, this is a single path end-to-end solution, for which the prediction is made by the sender based on a statistical characterization of the historical transmission rates. To base the prediction on historical transmission rates results in transmission rate adaption often being incorrect for changing communication network conditions, e.g. for mobile devices.

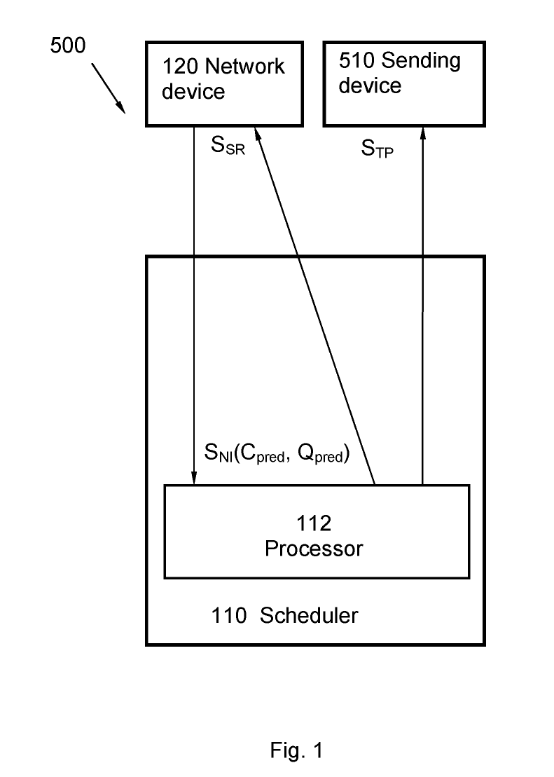

FIG. 1 is a schematic illustration of a scheduler 110 for a communication network 500 according to an embodiment. The scheduler 110 comprises a processor 112. A skilled person would realize that the scheduler may also comprise more units, such as a receiver unit and/or a transmitter unit.

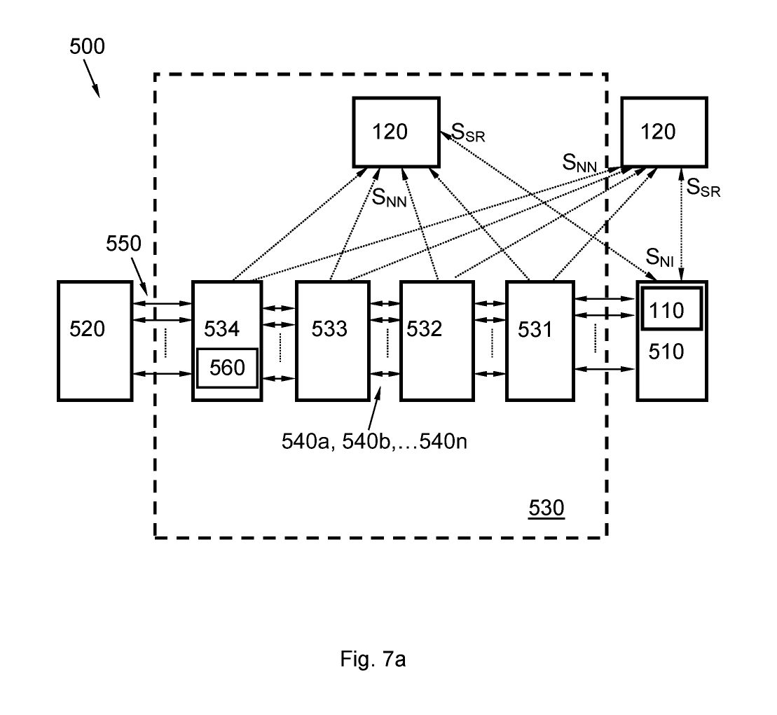

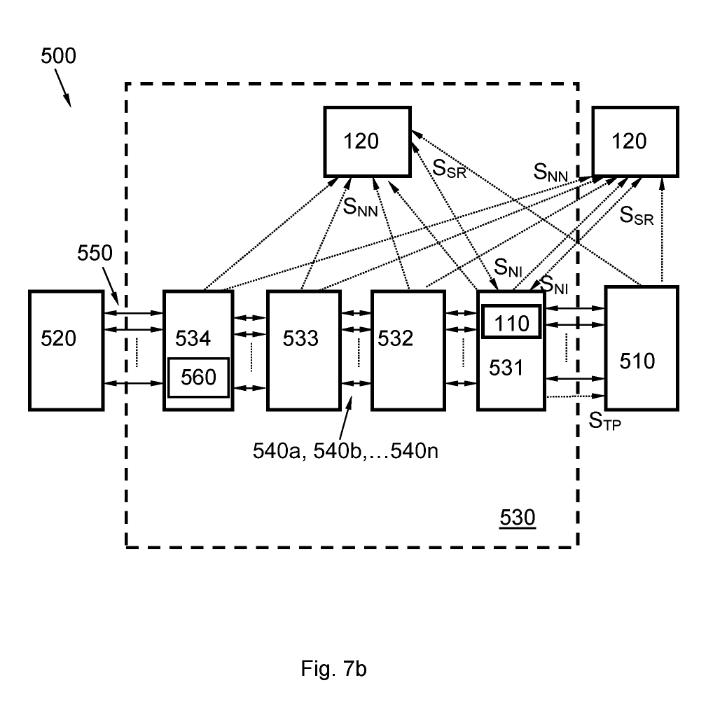

The processor 112 is configured to receive at least one predicted congestion level C_{pred} and at least one predicted radio channel quality Q_{pred} associated with a data flow 540a, 540b, . . . , 540n. The data flow 540a, 540b, . . . , 540n is illustrated and described below in connection with FIGS. 7a-b. The at least one predicted congestion level C_{pred} and at the least one predicted radio channel quality Q_{pred} can, according to some embodiments, be received from a network device 120, and can be included in a network information message S_{NI}, as described herein below.

The processor 112 is further configured to determine at least one of a transmission rate T_{R} or a data flow path T_{P} to be used for the data flow 540a, 540b, . . . , 540n based on the received predicted congestion level C_{pred} and the predicted radio channel quality Q_{pred}.

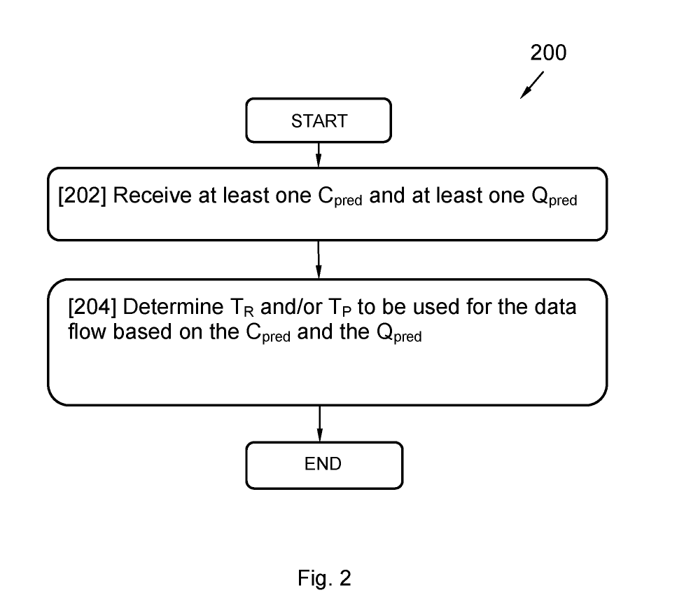

FIG. 2 is a flow chart diagram for a method 200 for a scheduler 110 in a communication network 500 according to an embodiment.

At 202, at least one predicted congestion level C_{pred} and at least one predicted radio channel quality Q_{pred} associated with a data flow 540a, 540b, . . . , 540n are received from a network device 120.

At 204, at least one of a transmission rate T_{R} or a data flow path T_{P} to be used for the data flow 540a, 540b, . . . , 540n is determined based on the received predicted congestion level C_{pred} and the predicted radio channel quality Q_{pred}.

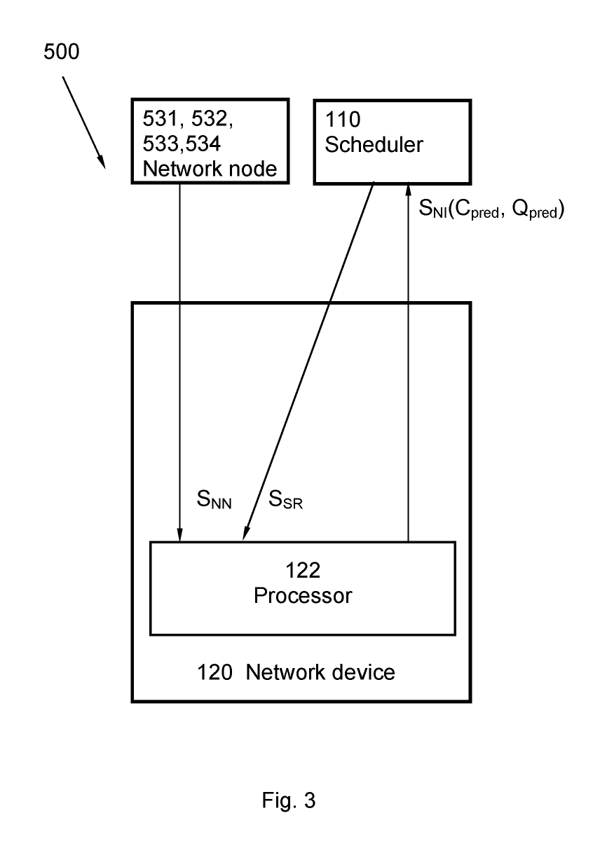

FIG. 3 schematically illustrates a network device 120 for a communication network 500 according to an embodiment. The network device 120 comprises a processor 122. A skilled person would realize that the network device 120 may also comprise more units, such as a receiver unit and/or a transmitter unit.

In one embodiment, processor 122 is configured to identify a data flow 540a, 540b, . . . , 540n for at least one receiving device 520. The data flow 540a, 540b, . . . , 540n and the receiving device are described below in connection with FIGS. 7a-b.

In one embodiment, the processor is further configured to determine at least one predicted congestion level C_{pred} and at least one predicted radio channel quality Q_{pred} associated with the data flow 540a, 540b, . . . , 540n.

In one embodiment, processor 122 is further configured to send the predicted congestion level C_{pred} and the predicted radio channel quality Q_{pred} to at least one scheduler 110. The at least one predicted congestion level C_{pred} and at the least one predicted radio channel quality Q_{pred} can, according to an embodiment, be sent included in a network information message S_{NI}, as described herein below.

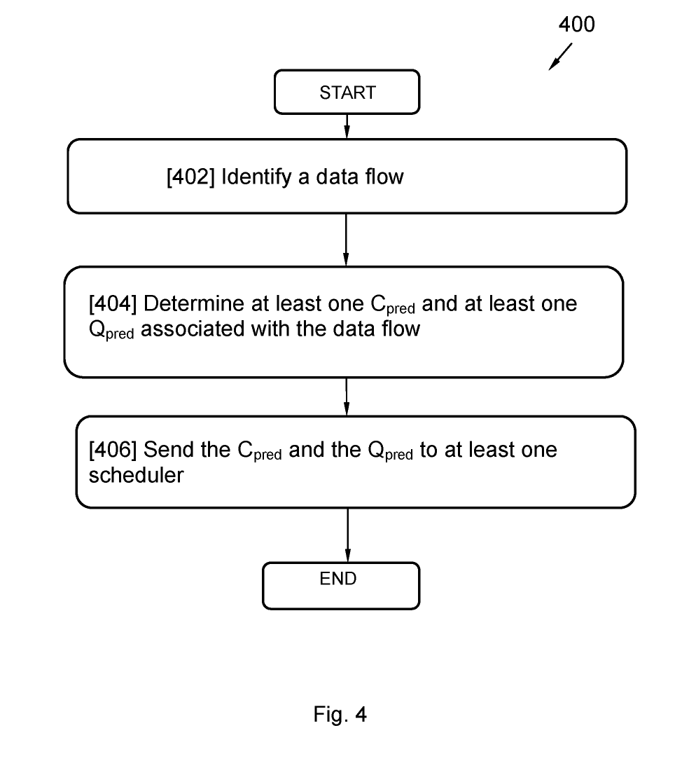

FIG. 4 is a flow chart diagram for a method 400 for network device 120 in a communication network 500 according to an embodiment.

At 402, a data flow 540a, 540b, . . . , 540n for at least one receiving device 520 is identified.

At 404, at least one predicted congestion level C_{pred} and at least one predicted radio channel quality Q_{pred} associated with the data flow 540a, 540b, . . . , 540n are determined.

At 406, the predicted congestion level C_{pred} and the predicted radio channel quality Q_{pred} are sent to at least one scheduler 110, possibly in a network information message S_{NI}.

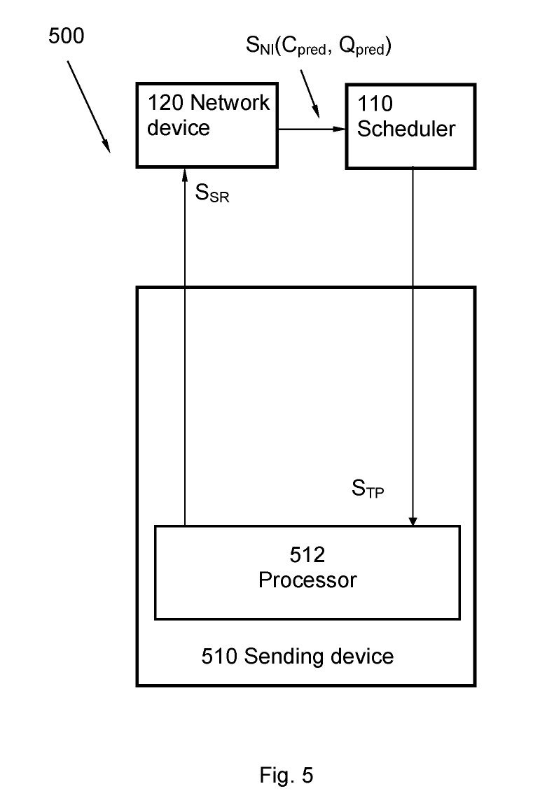

FIG. 5 schematically illustrates a sending device 510 for a communication network 500. The sending device 510 that comprises a processor 512. A skilled person would realize that the sending device 510 also can include more units, such as a receiver unit and/or a transmitter unit.

The processor 512 is configured to send a subscription request S_{SR}. The subscription request S_{SR} includes a request to send a predicted congestion level C_{pred} and a predicted radio channel quality Q_{pred} associated to a data flow 540a, 540b, . . . , 540n. According to some embodiments, the subscription request S_{SR} can include a specified prediction time period and/or can be sent to a network device 120. The predicted congestion level C_{pred} and the predicted radio channel quality Q_{pred} can, according to an embodiment, be sent from the network device 120 to a scheduler 110 included in a network information message S_{NI}. These embodiments are described below.

The processor 512 is further configured to receive at least one of a transmission rate T_{R} or a data flow path T_{P} to be used for the data flow 540a, 540b, . . . , 540n. The transmission rate T_{R} and/or the data flow path T_{P} can, according to an embodiment, be included in a transmission parameter message S_{TP} from the scheduler 110, as described below.

The processor 512 is further configured to adapt transmission of the data flow 540a, 540b, . . . , 540n based on the at least one of a transmission rate T_{R} or a data flow path T_{P}.

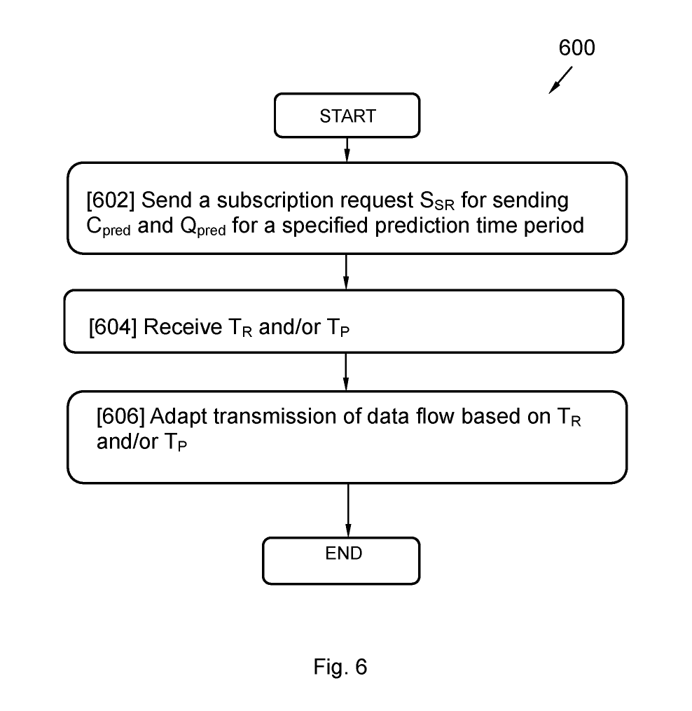

FIG. 6 is a flow chart diagram for a method 600 for a sending device 510 in a communication network 500 according to an embodiment.

At 602, a subscription request S_{SR} is sent to a network device 120. The subscription request S_{SR} includes a request to send a predicted congestion level C_{pred} and a predicted radio channel quality Q_{pred} associated to a data flow 540a, 540b, . . . , 540n for a specified prediction time period from the network device 120 to the scheduler 110, e.g. included in a network information message S_{NI}.

At 604, at least one of a transmission rate T_{R} or a data flow path T_{P} to be used for the data flow 540a, 540b, . . . , 540n is received from the scheduler, e.g. included in a transmission parameter message S_{TP}.

At 606, transmission of the data flow 540a, 540b, . . . , 540n is adapted based on the at least one of a transmission rate T_{R} or a data flow path Tₚ.

FIGS. 7a-b both schematically illustrate the communication network 500. FIG. 7a illustrates an embodiment for which the scheduler 110 is included/implemented within the sending device 510. FIG. 7b illustrates an embodiment for which the scheduler is included/implemented within a network node 531, 532, 533, 534 of an access network 530 being traversed by the at least one data flow 540a, 540b, . . . , 540n. For simplicity, the scheduler 110 is in FIG. 7b only illustrated as included/implemented in one network node 531. However, it should be understood that the scheduler 110 may also be included/implemented in another network node, such as network node 532, 533, 534, or in two or more of the network nodes 531, 532, 533, 534.

The network device 120 can be included/implemented in an access network 530 being traversed by the data flow 540a, 540b, . . . , 540n and/or outside the access network 530, which is illustrated by two network devices 120 in FIGS. 7a-7b.

A sending device 510 is configured to send at least one data flow 540a, 540b, 540n to a receiving device 520. The sending device 510 and the receiving device 520 are thus included in an end system for the at least one data flow 540a, 540b, . . . , 540. The at least one data flow 540a, 540b, . . . , 540n traverses the access network 530 including one or more network nodes 531, 532, 533, 534, such as e.g. a packet data network gateway (PGW) 531, a serving gateway (SGW) 532, a router 533 and a radio base station 534, such as an eNB. The radio base station 534 might include a radio interface scheduler 560 configured to schedule transmission over a radio interface 550.

The sending device 510 can be an application server outside the access network 530, as is illustrated in FIGS. 7a-b.

The sending device 510 can also be an application server included in a virtual machine of a mobile edge computing (MEC) server in the access network 530. In that case, the network device 120 might be radio network information service (RNIS) device, which is part of the MEC platform. In some embodiments, the notation sending device 510 includes also virtualized server processes that are running in an MEC server.

The receiving device 520 can essentially be any kind of receiver, such as a mobile terminal, e.g. a user equipment (UE).

As described above, the sending device 510 can be configured to send a subscription request S_{SR} to the network device 120. The subscription request S_{SR} includes a request to send a predicted congestion level C_{pred} and a predicted radio channel quality Q_{pred} associated to a data flow 540a, 540b, . . . , 540n for a specified prediction time period. The subscription request S_{SR} can also be sent from the scheduler 110. The network device 120 is configured to send the predicted congestion level C_{pred} and the predicted radio channel quality Q_{pred} to the at least one scheduler 110, e.g. included in a network information message S_{NI}. The scheduler 110 is configured to receive the at least one predicted congestion level C_{pred} and at least one predicted radio channel quality Q_{pred}, e.g. included in the network information message S_{NI}, and to determine at least one of a transmission rate T_{R} or a data flow path T_{P} to be used for the data flow 540a, 540b, . . . , 540n based on the received predicted congestion level C_{pred} and the predicted radio channel quality Q_{pred}. The transmission rate T_{R} and/or the data flow path T_{P} are sent to the sending device 510, e.g. included in a transmission parameter message S_{TP}. The sender 510 is configured to receive at least one of a transmission rate T_{R} or a data flow path T_{P} to be used for the data flow 540a, 540b, . . . , 540n, e.g. included in a transmission parameter message S_{TP} from the scheduler 110. The sender 510 is further configured to adapt transmission of the data flow 540a, 540b, . . . , 540n based on the at least one of a transmission rate T_{R} or a data flow path T_{P}.

According to an embodiment, the processor 122 of the network device 120 is further configured to predict the at least one predicted congestion level C_{pred} and the at least one predicted radio channel quality Q_{pred}. The processor 122 can then be configured to receive at least one measured congestion level Cₘₑₐₛ and/or at least one measured quality level Qₘₑₐₛ from at least one network node 531, 532, 533, 534 along the data flow path T_{P}, e.g. included in a network node message S_{NN}. Predictions of the congestion level C_{pred} and/or of the radio channel quality Q_{pred} for the data flow path T_{P} can then be computed by the processor 122 based on the at least one measured congestion level Cₘₑₐₛ and/or on at least one measured quality level Qₘₑₐₛ.

According to an embodiment, the processor 122 is further configured to receive from at least one radio interface scheduler 560 a transmission rate determined by the at least one radio interface scheduler 560 to be used for the data flow 540a, 540b, . . . , 540n over the radio interface 550. The processor 122 is then configured to predict at least one of the congestion level C_{pred} or the radio channel quality Q_{pred} based also on the transmission rate determined by at least one radio interface scheduler 560. Accordingly, an efficient prediction of at least one of the congestion level C_{pred} or the radio channel quality Q_{pred} is achieved, since the prediction is also based on a transmission rate which is actually going to be used for the radio interface. The transmission rate already determined for the radio interface can thus be used as a starting point for the prediction calculations.

According to another embodiment, the processor 122 of the network device 120 is further configured to receive the predicted congestion level C_{pred} and the predicted radio channel quality Q_{pred} from at least one network node 531, 532, 533, 534 of the access network 530. For example, the predicted congestion level C_{pred} can be provided by a one or more of the network nodes 531, 532, 533, 534, and the predicted radio channel quality Q_{pred} can be provided by a wireless access node 534. The at least one network node 531, 532, 533, 534 has then collected information about network load, congestion, radio channel quality, radio environment maps, user mobility and/or flow admission from multiple network nodes and has predicted the congestion level C_{pred} and the radio channel quality Q_{pred} based on this collected information.

According to an embodiment, the processor 122 of the network device 120 is further configured to determine the at least one predicted congestion level C_{pred} and the at least one predicted radio channel quality Q_{pred} for a prediction time period, wherein a length of the prediction time period depends on at least one requirement of an application using the at least one data flow 540a, 540b, . . . , 540n, i.e. of an application of the end system 510, 520.

There can also be two or more receiving devices receiving the at least one data flow 540a, 540b, . . . , 540n. The processor 122 of the network device 120 can then be configured to determine the predicted congestion levels C_{pred} and the predicted radio channel qualities Q_{pred} for each one of the two or more receiving devices 520. The at least two predicted congestion levels C_{pred} and at the least two predicted radio channel qualities Q_{pred} can then be sent to the scheduler 110 either in separate network information messages S_{NI} for each one of the at least two receiving devices 520, or can be sent together to the scheduler 110 in one single network information message S_{NI} including all of the at least two predicted congestion levels C_{pred} and at the least two predicted radio channel qualities Q_{pred}. The network information message S_{NI} may also include timing information that indicates the start of the prediction time periods for each data flow. This is in particular useful when a single information message carries predicted congestion levels C_{pred} and predicted radio channel qualities Q_{pred} for multiple data flows, since the timing information of the prediction time periods cannot always be implicitly derived from the timing of the network information message S_{NI}.

According to an embodiment, the processor 122 of the network device 120 is further configured determine the at least one predicted congestion level C_{pred} and the at least one predicted radio channel quality Q_{pred} for one data flow as a combined value including the at least one predicted congestion level C_{pred} and the at least one predicted radio channel quality Q_{pred}. This combined value can then be sent to at least one scheduler 110.

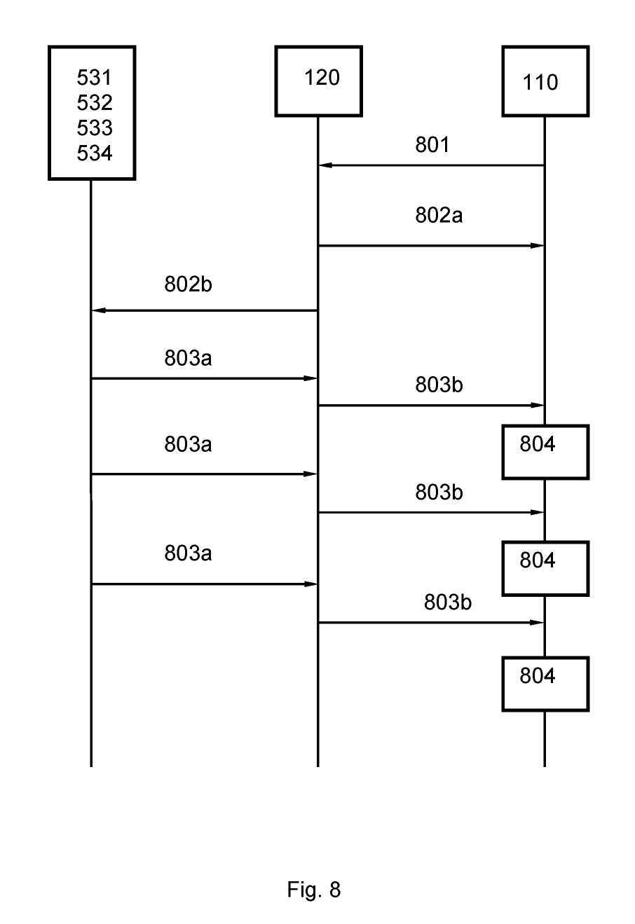

FIG. 8 shows a flow chart diagram illustrating some embodiments of the scheduler 110 and the network device 120. The basic idea here is that the scheduler will be provided with the predicted information if it is entitled to it and has requested it.

A scheduler 110 and/or a sending device 510 entity send a subscription request S_{SR} 801 to the network device 120, which e.g. can be an information server of a mobile operator network. The subscription request S_{SR} includes a request to send the predicted congestion level C_{pred} and the predicted radio channel quality Q_{pred} associated to the data flow 540a, 540b, . . . , 540n to the scheduler 110 for a specified prediction time period/horizon.

The processor 122 of the network device 120 can further be configured to receive the subscription request S_{SR} associated with the data flow 540a, 540b, . . . , 540n. 2a. The subscription request S_{SR} can also, according to an embodiment, include a flow identification information (flow ID), as described below. The processor 122 of the network node can then be configured to receive the flow identification information and to identify the data flow 540a, 540b, . . . , 540n based on the received flow identification information. The processor 122 checks that the scheduler 110 and/or sending device 510 is authorized to subscribe to the predictive information and responds with a message 802a indicating a positive or negative response, and also indicating details about the predicted information it can provide. This step may include contacting further servers for the security procedures.

The processor 122 of the network device 120 is further configured to also send out an information request 802b to the network nodes 531, 532, 533, 534 that can provide relevant channel and congestion information. If the network device does not have information about the data flow path T_{P} of the data flow 540a, 540b, . . . , 540n, it may need to involve a node that has the required routing information to access the information.

The network nodes 531, 532, 533, 534 report in network node messages S_{NN} 803a channel quality and congestion information to the network device 120, either as measured values Cₘₑₐₛ, Qₘₑₐₛ or as predicted values C_{pred}, Q_{pred}. Each report may include information for multiple users.

The processor 122 of the network device 120 periodically provides the predicted information values C_{pred}, Q_{pred} on a per flow basis to the scheduler 110 in network information messages S_{NI} 803b. According to some embodiments, the time period between the network information messages S_{NI} 803b may be short, e.g. in the order of milliseconds. In most embodiments, the network device 120 will process and/or rearrange the information received in the network node messages S_{NN} 803a before sending the information to the scheduler 110. For example, the network device 120 might use measured values Cₘₑₐₛ, Qₘₑₐₛ received in the network node messages S_{NN} 803a to calculate the predicted congestion level C_{pred} and the predicted radio channel quality Q_{pred}.

According to an embodiment, the processor 122 of the network device 120 is further configured to compute the predicted congestion level C_{pred} and the predicted radio channel quality Q_{pred} for the prediction time period specified in the subscription request S_{SR} if it is possible to perform this computation, and to send that predicted congestion level C_{pred} and the predicted radio channel quality Q_{pred} to the scheduler 110 in a network information message S_{NI}. However, if it is not possible to perform such a computation, the processor 112 is configured to instead compute a predicted congestion level C_{pred} and a predicted radio channel quality Q_{pred} for another prediction time period. This other prediction time period should then be the time period being closest in time, e.g. of most similar length, to the prediction time period specified in the subscription request S_{SR} for which time period it is also possible to compute the predicted congestion level C_{pred} and the predicted radio channel quality Q_{pred}. In other words, if it is impossible to perform the prediction calculations for the prediction time period specified in the subscription request S_{SR}, then the prediction calculations should instead be made for another time period e.g. with a length similar to the specified prediction time period during which they can be performed.

According to an embodiment, the processor 122 of the network device 120 is further configured to only send the predicted congestion level C_{pred} and the predicted radio channel quality Q_{pred} the scheduler 110 if the scheduler 110 is authenticated as subscribing to a service delivering the predicted congestion level C_{pred} and the predicted radio channel quality Q_{pred}. This is handled by the signaling described above for FIG. 8.

At 804, the processor 112 of the scheduler 110 is further configured to determine at least one of a transmission rate T_{R} or a data flow path T_{P} to be used for the data flow 540a, 540b, . . . , 540n based on the predicted congestion level C_{pred} and the predicted radio channel quality Q_{pred}. The determination of the transmission rate T_{R} and/or the data flow path T_{P} to be used is performed for a specified prediction time period, where the prediction time period is specified by a subscription for the data flow 540a, 540b, . . . , 540n, e.g. as being included in the subscription request message S_{SR} 801 from the scheduler 110 and/or the sending device 510. The scheduler 110 and/or the sending device 510 can here be configured to determine a length of the prediction time period based on at least one of latency requirements or rate adaptability for an application, and to add this determined prediction time period in the subscription request message S_{SR} 801.

The scheduler 110 is configured to set priorities for the different flows 540a, 540b, . . . , 540n based on the predicted congestion level C_{pred} and the predicted radio channel quality Q_{pred}.

The processor 112 of the scheduler 120 can, according to an embodiment, be further configured to receive predicted congestion levels C_{pred} and predicted radio channel quality values Q_{pred} for at least two prediction time periods and/or for multiple users of the service provider server in each one of the network information messages SNI.

According to an embodiment, the processor 112 of the scheduler 110 is further configured to determine at least one of the transmission rate T_{R} or the communication path T_{P} based also on at least one of predetermined transmission resources or predetermined congestion volumes being available for the at least one sending device 510. Such volumes may be specified in contracts between service providers controlling the sending device 510 and network operators controlling the access network 530.

According to an embodiment, the processor 112 of the scheduler 110 is further configured to determine the transmission rate T_{R} based also on an access network policy indicating a change of the transmission rate T_{R} based on the predicted congestion level C_{pred} and the predicted radio channel quality Q_{pred}.

According to an embodiment, the processor 112 of the scheduler 110 is further configured to determine the transmission rate T_{R} as a lower transmission rate T_{R}_{_}_{low} for a first prediction time period than the transmission rate being set for a second subsequent prediction time period, if it is predicted that the congestion level C_{pred} will be lower and/or the channel quality Q_{pred} will be better in the second prediction time period than in the first prediction time period.

According to an embodiment, the processor 112 of the scheduler 110 is further configured to determine the transmission rate T_{R} as a higher transmission rate T_{R}_{_}_{high} for a first prediction time period than the transmission rate being set for a second subsequent prediction time period, if it is predicted that the congestion level C_{pred} will be higher and/or the channel quality Q_{pred} will be worse in the second prediction time period than in the first prediction time period.

According to an embodiment, the processor 112 of the scheduler 110 is further configured to determine the data flow path T_{P} as a new data flow path T_{P}_{_}_{new}, if it is predicted that the congestion level C_{pred} will be lower and/or the channel quality will be better during a coming prediction time period for the new data flow path T_{P}_{_}_{new} than for a currently used data flow path T_{P}_{_}_{current}.

As is mentioned above, the channel conditions for the data flow through the access network 530 is predicted both in terms of congestion level and radio channel quality.

A network node 531, 532, 533, 534, e.g. a base station or a control node in the access network 530, or the network device 120, can make a prediction of the channel quality Q_{pred} for a user for a certain specified time period. The predicted channel quality Q_{pred} can be translated to a modulation and coding scheme (MCS) and/or to a transmission error probability, which indicates how spectrally efficient the transmission will be for the user.

The channel condition prediction, i.e. the prediction of the congestion level C_{pred} and the channel quality Q_{pred} can be made by using predicted movement patterns, e.g. along roads, and/or radio performance maps, e.g. based on historical measurements. In particular, in a radio access network with very accurate network based positioning of user devices, it is possible to construct radio performance maps with fine granularity that can be used for prediction of the channel quality. For example, an embodiment using the radio performance maps would indicate a typical channel quality, e.g. a MCS and/or an error probability, that could be used in a given area, based on previously measured performance for users in that area. The prediction of the channel quality Q_{pred} can then be made based on the predicted movement. The prediction can then for example be made as a linear prediction, where the speed and direction of the movement is expected to be constant. The prediction can also be made by calculating an expected value for the channel quality based on a probability distribution of the future location, e.g. based on a weighted average of the channel qualities in multiple areas.

In general, the prediction can be made by different methods, which results in different prediction horizons. For example, the prediction may span over user movements between different access nodes 534, i.e. the prediction may include one or more handovers. Changes in the channel quality Q_{pred} can then be predicted if the access network 530 is aware that the source and target access nodes 534 for a handover provide significantly different channel qualities. The mobility management in the radio access network, e.g. a handover algorithm for an eNB and/or a radio network controller, can here provide input to the prediction. In this case, the prediction horizon can be relatively long, e.g. in order of seconds.

However, the prediction may also be performed for time spans during which the user is connected to the same access node 534, reflecting e.g. shadowing or predictable interference periods. Shadowing by fixed objects could be predictable if the user movement can be predicted, and shadowing by moving objects can also be predictable if the movement of the objects would be observable by other access network entities. The interference time periods may be predictable in cases where the access network is relying on highly directional transmissions, for example when beam forming is used. By using information about the directions of beams used for different users, the interference may thus be predictable. For the above described embodiments, the prediction may preferably be made in a central node for some types of predictions, or may preferably be made by the access node 534 for other types of predictions.

The congestion level in a network node 531, 532, 533, 534 can be defined in different ways. For example, the congestion level can be generated by some function that includes averaging or low pass filtering of queue levels. In many cases, the radio access link, i.e. the radio interface 550, will be the bottleneck of the whole data flow path T_{P}, and will therefore be the most congested link of the path. This means that giving predicted information about the radio access link 550 will be sufficient to allow the scheduler 110 to make well-informed decisions. In cases where the radio access link 550 is not dominating the congestion of the end-to-end path, some embodiments may still give predicted information about the radio access link 550 only. In this case, the scheduler 110 can estimate how much the congestion of the rest of the path is by comparing how the predicted congestion for the radio interface 550 compares to the actually experienced congestion. This estimation can then be made after a congestion feedback, e.g. explicit congestion notification (ECN) feedback, has been received.

According to other embodiments, the predicted congestion level C_{pred} of the whole data flow path T_{P} can be provided in the feedback. This information may be collected from measurements of e.g. load or queue levels made in multiple network nodes 531, 532, 533, 534 along the data flow path T_{P}, for example gateways, routers and/or switches. This is especially useful if the whole data flow path T_{P} is under control of one access network operator, such that it is possible to make a reasonable estimate of the congestion. Moreover, when the channel quality information is related to a single link while the congestion information is related to the whole data flow path T_{P}, it is preferable to provide them as separate information elements so that the scheduler 110 can use the information according to its preferred policies.

The time scale of averaging used for the predictions is an important aspect, and it should in general be possible to support congestion control mechanisms that can provide instantaneous congestion level feedback, i.e. without averaging. However, it is difficult to make accurate predictions of congestion levels that are not averaged, since they may change/vary quickly. Therefore, the predicted congestion level C_{pred} can in some embodiments be an averaging of measured congestion levels during a time period. This would mean that the congestion feedback used by a transport protocol could be unfiltered and highly variable while the predicted congestion value C_{pred} used according to the embodiment would indicate a predicted average value for the congestion feedback. According to other embodiments, the access network nodes 531, 532, 533, 534 may use measurements made for other purposes and/or may use admission control decisions to make a prediction of the congestion level. Since the admission control function has knowledge of data flows that will start in the near future, and often has knowledge of the load situation in a larger area of a mobile network covering several base stations, it can make rather accurate predictions. According to one embodiment, the congestion information is provided by a radio access network (RAN) Congestion Awareness Function (RCAF) defined by 3GPP standardization documentation. The RCAF is not likely to provide predictions of future congestion levels, and the information provided to the sending device 510 and/or the scheduler 110 may therefore be limited to a prediction that the congestion will remain at the same level as before.

According to some embodiments, the congestion level is defined individually for each user, taking into account the individual physical resource usage for each user. The individual congestion level is then a function of the general load or congestion of a shared resource and the radio channel quality for a user, e.g. as indicated by the selected MCS. A user with worse radio channel quality would experience a higher individual congestion level than a user with better radio channel quality, even though the shared resource has the same level of congestion. This reflects that it requires more spectral resources per bit to transmit to the user with worse radio channel quality than to transmit to the user with better radio channel quality. Since the radio channel quality is not directly observable by the scheduler 110, it is an efficient solution to incorporate the radio channel quality into the congestion signalling. Since the congestion signaling is also used by already existing transport protocols, this does not require changes in the transport protocols. In this case, the feedback from the access network 530 can preferably be provided as individual congestion level predictions for each data flow. The access network 530 may here add the individual channel dependent congestion levels to congestion levels of other link/path segments to generate an individual end-to-end congestion metric. Addition, e.g. performed for adding congestions levels, may here in some embodiments be understood in the same sense as adding probabilities P of independent events e1, e2, i.e. P(e1,e2)=P(e1)+P(e2)−P(e1)*P(e2).

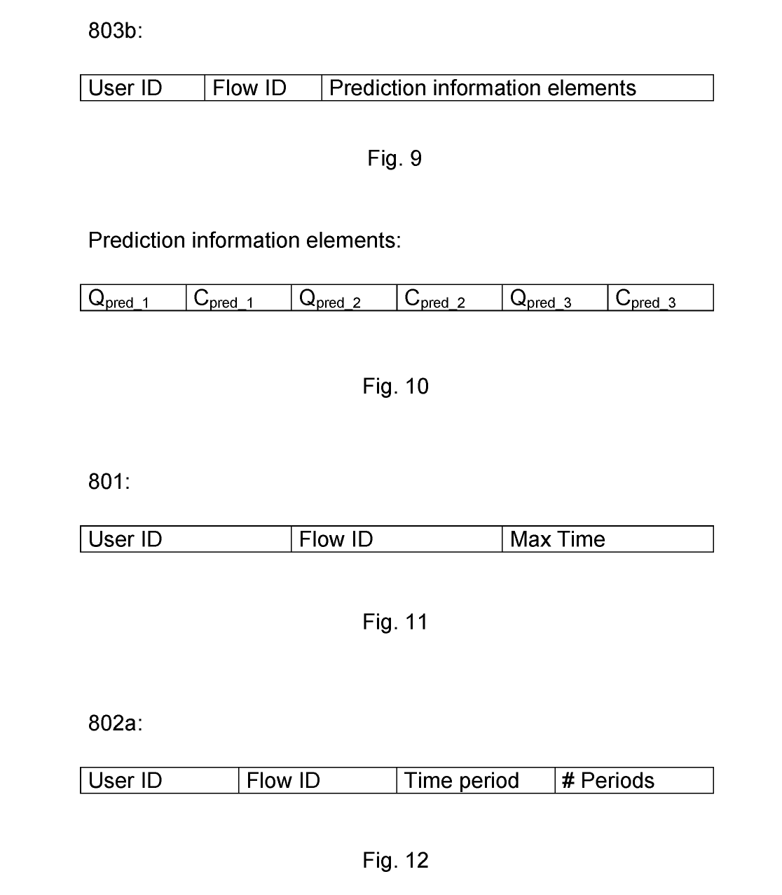

FIGS. 9-12, illustrate exemplary forms of messages that may be used for signalling according to some embodiments. It should be understood that the messages also can have other names, forms and/or content than illustrated in these figures.

As mentioned above, the information can be provided from the network device 120 to the scheduler 110 either as separate values for predicted congestion level C_{pred} and predicted channel quality Q_{pred}, or it can be provided as an individual congestion value. In the latter case, the individual congestion value will be a function both of the predicted congestion level C_{pred} and the predicted channel quality Q_{pred} for a receiving device 520. As illustrated in FIG. 9, the network information message S_{NI} 803b (also illustrated in FIG. 8) may include a user ID, a flow ID (since the receiver device 520 may have multiple flows with different congestion levels, e.g. if they use different traffic classes or data flow paths), and a description of the predicted information. The predicted information may be described as an array of congestion values C_{pred} and/or channel quality values Q_{pred} for multiple time periods.

According to some embodiments, the user ID may be an internet protocol (IP) address of the receiving device 520, and according to some embodiments the user ID may also include a port number. According to other embodiments, the user ID may be an international mobile subscriber identity (IMSI), a universal resource identifier (URI) such as a session initiation protocol (SIP) URI, or a temporary mobile subscriber identity (TMSI).

The flow identification information (flow ID) may, according to some embodiments, be an Internet Protocol version 6 (IPv6) data flow label. According to other embodiments, the flow ID may be a combination of IP addresses, port numbers and protocol types that identifies the flow, either on its own or in combination with the user ID. According to some embodiments, the flow ID may be a bearer ID. According to some embodiments, the flow ID may be a tunnel identifier or a tunnel endpoint identifier. According to other embodiments the flow ID may be a virtual local area network (LAN) identifier/tag.

In FIG. 10, an example of a format of the predicted information element in the network information message S_{NI} 803b is shown. In the shown example, information for three different time periods is included as separate channel qualities Q_{pred}_{_}₁, Q_{pred}_{_}₂, Q_{pred}_{_}₃ and congestion levels C_{pred}_{_}₁, C_{pred}_{_}₂, C_{pred}_{_}₃. The length of the time period is not explicitly included in the example, since it may be known from the above described initial information request procedure. However, the length of the predicted periods may also be included explicitly in the network information message S_{NI}. The channel quality information Q_{pred}_{_}₁, Q_{pred}_{_}₂, Q_{pred}_{_}₃ may be indicated as an index of a modulation and coding scheme, or as a metric which provides a relative quality measure. Also, the congestion level information C_{pred}_{_}₁, C_{pred}_{_}₂, C_{pred}_{_}₃ may be indicated as a metric which provides a relative congestion value. These values for the radio channel quality and/or the congestion level can be encoded in a few bits, e.g. 4 bits each, where a value of 0000 may correspond to the lowest channel quality and the lowest congestion, while 1111 could correspond to the highest channel quality and the highest congestion, respectively.

According to some embodiments, the predicted information elements may also include time information for the prediction time periods. This can be a field with absolute start time for each prediction time period, or with a start time being relative to a suitable time reference. This is advantageous since it allows the network device 120 to provide the scheduler 110 with more accurate prediction time period information when predicted network information related to multiple users/receivers and data flows are sent in the same packet, thereby making it difficult to use implicit time information.

According to an embodiment, the network device 120 can provide a single flow specific congestion value per prediction time period. This value could for example be calculated as:

$$\frac{congestion metric}{channel efficiency of the user} , or as \text{:}$$

$$\frac{congestion metric}{normalized channel quality of the user} .$$

The congestion metric used here for the calculations can typically be a value between 0 and 1, which reflects the congestion level in a way analogous to packet loss probability due to buffer overflow. The normalized channel quality used in the calculations can be a measure of how close the user/receiver is to the maximum nominal transmission rate of the radio interface 550.

According to some embodiments, the scheduler 110 may be provided with both expected predicted values for the radio quality Q_{pred} and the congestion level C_{pred}, and with measures of the uncertainty of the prediction, e.g. in the form of an estimated standard deviation for the prediction.

FIG. 11 illustrates an example of a subscription request message S_{SR} 801 (also illustrated in FIG. 8). The subscription request message S_{SR} 801 can, according to some embodiments, comprise a user ID, a flow ID, and a description of the preferred time horizon for the prediction (Max Time). The Max Time value may for example be given in seconds, or milliseconds.

FIG. 12 illustrates an example of a subscription response message 802a (also illustrated in FIG. 8). The subscription response message 802a, which normally is transmitted during the setup, may include the user ID, flow ID, the length of each prediction time interval (or time period), e.g. in seconds or milliseconds, and the number of intervals or periods) that is included in each network information message S_{NI} 803b. The network device 120 can determine the interval length and the number of intervals based on its prediction capabilities, and tries to match the requested maximum time requested by the sending device 510 and/or the scheduler 110.

The network device 120, which e.g. can be a network information server, can be integrated in a gateway 531 to the access network 530, e.g. a packet data network (PDN) gateway (GW) in an evolved packet core (EPC) network, or in a base station/eNB 534.

According to some embodiments, the network device 120 collects prediction information from multiple sources 531, 532, 533, 534 and forwards the information to the scheduler 110. The prediction information about the radio channel conditions, i.e. the radio channel quality Q_{pred} will then be provided by the base station/eNB or a control node closely related to the base station/eNB, e.g. a Radio Network Controller (RNC). The congestion information C_{pred} may then be provided either from the base station/eNB 534 or it may be collected from another node 531, 532, 533 in the access network 530. If the network device 120 is located in a different node than the base station/eNB 534, it may need to collect information from the base stations/eNBs 534. An advantage of having the network device 120 in a node 531, 532, 533 separate from the base station/eNB is that it will more easily have access to information that is useful for the prediction, e.g. information about load in neighboring base stations, and radio map information. It may also have access to more processing power. A further advantage is that the impact of user/receiver mobility is smaller, since the prediction processing does not need to move when a user/receiver changes serving base station.

The signaling between the network nodes 531, 532, 533, 534 and the network device 120, and between the network device 120 and the scheduler 110 should be limited to a reasonable amount. Each message may comprise tens of bytes per data flow, and both the transport/network nodes and the network device 120 can aggregate information for multiple users/receivers into the same packet to limit the overhead. This could e.g. result in one IP packet every 10 ms per transport/network node, and another IP packet per scheduler 110. An IP packet to a transport/network node can e.g. comprise information for all data flows passing through that transport/network node. An IP packet to a scheduler can e.g. comprise information for all data flows being handled by that scheduler.

According to some embodiments, the base station/eNB 534 may inform the network device 120 about the radio channel conditions for each bearer. The network information server may map the information for each bearer to the data flows that belong to different schedulers 110, and may provide the information to the correct scheduler 110.

The scheduler 110 can be configured to schedule the traffic/transmissions from the sending device 510, being e.g. a sending application server, based on the predicted channel conditions, i.e. based on the predicted radio quality Q_{pred} and the predicted congestion level C_{pred}. This can be implemented in a number of different ways according to different embodiments, which is described below.

For example, scheduling of the traffic can be implemented with new transport protocols, with traffic pacing below the transport protocols or with traffic management above the transport protocols. The scheduling of the traffic may for example depend on the length of the prediction interval. Traffic pacing below the transport protocols can be implemented by having a transmit buffer for the data which is passed from the transport protocols to lower protocol layers, e.g. to the IP layer. In some embodiments the buffer may even be implemented/located in some node on the path, e.g. in a gateway. This would mainly be useful for applications that do not have requirements on low latency.

According to an embodiment, traffic management above the transport protocols is utilised since this is efficient from a practical perspective. The scheduler could in this case be implemented as a traffic manager which provides each transport protocol instance with an amount of data that corresponds to the transmission rate being suitable for each transmission time period. The traffic manager should preferably also be able to control and/or interact with the sending application in order to optimize the transmission rate adaptation in an application specific way which minimizes a degradation of the quality of experience. However, this may not be needed for all applications. By scheduling the transmissions based on predicted channel conditions, the scheduler 110 has a possibility to minimize the need for buffering of packets of the data flow in the network nodes 531, 532, 533, 534. The network nodes 531, 532, 533, 534 will, however, still have buffers and schedulers in order to handle unpredictable changes in the channel conditions, traffic levels and/or other inaccuracies in the prediction of the channel conditions.

According to an embodiment, the sending device 510 has dedicated hardware configured to handle the processing of the network protocols, e.g. transmission control protocol (TCP) offload engines (TOE). For embodiments where the scheduler 110 is not implemented in the offload engines, the scheduler 110 will need to control the transmission from the offload engines, either by how much data it schedules and/or provides to the offload engine for each flow, or by explicit signalling to the offload engine, if the protocols are able to use the explicit transmission rate and data flow path signalling information directly. To control the amount of data provided to the offload engines works well if the prediction intervals are of a length which corresponds to an interval at which the scheduling process can efficiently treat each flow. However, in some cases the prediction intervals may be short and the scheduler processing may be more efficient if the scheduler process directly feeds the predicted information to the offload engines so that the processes running in the offload engines can use the predicted information. This would require the protocols running in the offload engine to be adapted to use predicted network information.

According to an embodiment, the scheduler 110 is handling traffic to a number of mobile users/receiving devices 520 connected to an access network 530. As mentioned above, the scheduler 110 can then conform to a policy for how much total congestion it is allowed to cause in the network, or how much resources, e.g. defined as physical resource blocks (PRBs) in long-term evolution (LTE) or as transmission rate, it is allowed to use. Using the feedback about the predicted channel conditions for different users, the scheduler 110 can distribute its quota of resources to the users that have the highest utility from the resources at any given time. When users/receivers 520 are mobile, their conditions will change over time both due to changes in the radio conditions and due to more competition for the resources in areas where there are many users. With a policy based on congestion volume or resource volume it is therefore favourable for the scheduler 110 to distribute its transmission quota to the users/receivers 520 that experience good channel conditions in terms of high radio channel quality and low congestion levels. The congestion volume can here be defined as a dimensionless metric for a level of congestion multiplied with the traffic volume, e.g. in form of a number of packets or bytes.

If the applications allow that the transmissions are shifted in time, a more efficient usage of the network resources is also allowed. The scheduler 110 can therefore use knowledge of the application requirements to determine how to schedule the transmissions of the data flow in an efficient way. This has an advantage in that the network resources can be used more efficiently than if the scheduler would use a policy on the data rate or data volume it can transmit.

In order to make the cooperation between the scheduler 110 and the radio interface scheduler 560 at the wireless base station 534 efficient, it may be preferable to establish policies that make the behavior mutually predictable. The radio interface scheduler 560 provides information to the network device 120, which forwards it, processed or unprocessed, to the scheduler 110.

According to an embodiment, when the radio interface scheduler 560 makes the prediction of the channel quality Q_{pred} for multiple users/receivers 520, the radio interface scheduler 560 can make better predictions if it knows the likely behaviour of the scheduler 110 and the sending device 510. As an example, a policy may therefore say that the sending device 510 should in general increase the amount of data it transmits to a user/receiver 510 when the channel for the user improves. The sending device 510 could still have some freedom to use a rate that corresponds to the required transmission rate for the user/receiver 520, but the transmission behaviour of the sending device 510 would then be quite predictable. Policies may also be more quantitative as to how much the sending device 510 should follow the predictions from the scheduler 110.

According to an embodiment, the radio interface scheduler 560 provides the scheduler 110 with a prediction of the radio channel quality, which includes a predicted transmission rate for the data flow. The radio interface scheduler 560 then schedules resources in the radio interface for the data flow such that the service rate for the user/receiver 520 corresponds to the indicated transmission rate. If the scheduler 110 follows the indicated rate it is therefore possible to forward the traffic with very low delay. It can be used as a guaranteed bit rate quality class where the bit rate is guaranteed with a very high probability, but only for a limited prediction period. This is different from conventional guaranteed bit rate services, which attempt to provide the same bit rate during the whole session but cannot fulfil the guarantees when the channel quality is bad. With the guaranteed bit rate quality class according to the embodiment, however, the sending device 510 would be able to adapt e.g. the source coding according to the predicted channel. This embodiment is favourable e.g. when the data flow path between the sending device 510 and the base station/eNB 534 does not have any significant bottlenecks and when the sending device 510 does not serve many users, for example if the sending device 510 is located in an MEC server within the radio access network.

According to an embodiment, a cache memory can be included/implemented within the base station/eNB 534 or included/implemented in another node in the access network, e.g. a gateway or a radio network controller. The cache memory then caches a part of the data that is sent by the sending device 510. The scheduler 110 may here subscribe to prediction information for a relatively long time horizon and let the sending device send data to one or more base stations/eNBs 534 according to the predicted congestion C_{pred} and channel quality Q_{pred}. The data from the cache memory may be delivered to the receiver device 520 based on the short term control by the radio interface scheduler 560. According to a further embodiment, the cache memory may deliver data to the transmission queue within the eNB 534 according to a short prediction time period. The cache memory may therefore request a separate prediction subscription with a short time horizon. According to an example of this embodiment, the cache memory may be an application in an MEC server.

According to an embodiment, the data communication between the sending device 510 and the UE/receiving device 520 is performed by using the HyperText Transfer Protocol/2 (HTTP/2) protocol. By usage of the HTTP/2 protocol mechanisms, the sending device 510 may proactively push resources to the mobile client in the receiving device 520 during time intervals when the channel is good compared to other predicted time intervals. Another mechanism supported by some protocols is to give the mobile clients hints that it shall pre-fetch content during favorable periods.

As mentioned above, the scheduler 110 can be implemented in the sending device 510. According to another embodiment, the scheduler 110 can also be implemented in a network node 531, 532, 533, 534 in the data flow path, e.g. a gateway, whereby the network node 531, 532, 533, 534 in the data flow path can provide some pacing of the traffic based on the predicted channel conditions. This could result in an efficient usage of access network resources with limited buffering.

According to an embodiment, the network device 120 provides the predicted channel condition information for all the data flows from a sending device 510. According a preferred embodiment, the predicted channel condition information is provided in accordance with an information provisioning protocol, which is separated from specific transport protocols used for the transmission of the data flows. This embodiment has an advantage in that it can be implemented with limited changes to existing protocols and device implementations. The information provisioning protocol may here for example use some markup language, e.g. eXtensible Markup Language (XML) or Javascript Object Notation (JSON), and/or text based transfer protocol, e.g. HyperText Transfer Protocol (HTTP). The main procedure and messages used for this embodiment would include the ones illustrated in, and above described for, FIGS. 8 to 11.

According to some embodiments, a sending device 510 and/or a scheduler 110 can subscribe to prediction information for all its sessions proactively. In such embodiments the access network 530 may trigger reporting of predicted channel condition information for every session that is being setup by the sending device 510 automatically. This triggering can be made for example by the policy and charging rules function (PCRF) or by the packet data network gateway (PGW).

According to an embodiment, the predicted information can be provided by an extension of the application layer traffic optimization (ALTO) protocol, which has been standardized by the interne engineering task force (IETF) for the purpose of providing information about preferable routing to hosts. According to the embodiment, it is proposed to extend the ALTO protocol with information about preferred transmission occasions in the time dimension, as a calendar mechanism. To support this solution, the ALTO protocol would need to be extended by including the users/receivers 520, and also flow specific congestion information, as shown in FIG. 8 and FIG. 9. The implementation would also need to support frequent information transfer. One advantage of using the ALTO protocol is that protocol mechanisms can be reused for tasks such as discovering a network device which acts as an information provisioning server. The ALTO protocol may also be extended with an option which provides periodical updates of the requested predicted information rather than requiring a request for every time that predicted channel condition information shall be provided.

According to another embodiment, the Diameter protocol is supplemented with newly defined attribute value pairs (AVP), and is used for providing the predicted channel condition information. The Diameter protocol is a protocol configured for authentication and accounting, which is used for several interfaces in mobile networks today. This embodiment has an advantage in that the protocol mechanisms related to e.g. security can be reused. This embodiment can be seen as an extension of the Rx interface in the EPC architecture, between the PCRF and the application function (AF), where the AF corresponds to the sending device/server 510, and would also include the scheduler 110. The network device 120 would then be integrated with the PCRF in this case. The current PCRF function is mainly intended for transporting application level session information from AF to PCRF, and for informing the AF about rare events such as a loss of a bearer, while the extension would be used to carry more frequent information in the other direction, from PCRF to the AF.

For this embodiment, a flow description AVP can be reused to define the user ID and the flow ID. Some new AVPs would also need to be introduced in the Diameter protocol, such as:

AVP to request subscription for predicted channel quality and/or congestion level information;

AVP with the time horizon of the prediction;

AVP with the number of prediction intervals; and

AVP with the predicted channel quality and/or congestion level information.

The Diameter protocol may also need to be extended with an option which provides periodical updates of the requested information rather than polling or event based information provisioning. It may also need to be extended to support aggregation of AVPs for multiple users in the same signalling message. This embodiment may further be combined with a RAN congestion awareness function (RCAF) that provides congestion information to the PCRF. The PCRF may then be extended with an interface which collects the radio channel quality information. Alternatively, the RCAF may be extended to also provide user specific radio channel quality information.

According to an embodiment, the interface between the network device 120 and the scheduler 110 is an interface between an RNIS and an application in a virtual machine of a MEC platform. In this case, the interface may also be an internal interface in a physical computer. This embodiment may also be combined with some other embodiments mentioned in this document. For example, the RCAF could provide congestion information to the RNIS, which could combine this with radio channel quality information and make predictions before providing it to the sending device which would be executing in a virtual machine. An advantage of this would be that existing network functions can be reused.

According to other embodiments, the predicted channel condition feedback can also be integrated into network layer or transport layer protocols. This requires some changes in the protocol stacks. For example, the predicted channel condition information may be provided to the scheduler 110 using an IP header extension. The predicted channel condition information could be added in the IP header extension either by a base station/eNB or by a gateway node in the path of the data flow.

According to another embodiment, the sending device 510 is transmitting data to users/receivers 520 with real time protocol (RTP). The predicted channel condition information can then be provided to the scheduler 110 by way of a new extension to the RTP control protocol (RTCP) receiver report (RR). The extended receiver report in the RTCP would then comprise information about a predicted channel quality Q_{pred} and congestion level C_{pred}. The added information in the RTCP RR extension, which is sent to the RTP scheduler 110, would then correspond to the information described in FIGS. 9 and 10. According to this embodiment, the user ID can be in the form of a canonical name record (CNAME) as used by RTCP.

The access network 530 may deploy RTCP middle boxes, e.g. translators or mixers, which collect the receiver reports from end users/receivers 520 in the network and aggregate the information. The predicted channel information may be provided by use of a real time streaming protocol (RTSP). This may be implemented by the GET_PARAMETER or SET_PARAMETER messages defined in the RTSP.

According to another embodiment, the sending device 510 is transmitting data using the TCP. The predicted channel condition feedback can then be provided in a TCP header extension. The predicted channel condition information can then first be provided to the receiving UE/client/device 520, which would include the predicted channel condition information in a new TCP header extension. However, to provide the predicted channel condition information from the access network 530 to the receiving UE/client/device 520, it would either be necessary for the network device 120 to change the TCP header in transit, or this embodiment could be combined with signalling through an IP header extension to the receiving TCP stack.

The radio interface 550 may at least partly be based on radio access technologies such as, e.g., 3GPP LTE, LTE-Advanced, Evolved Universal Terrestrial Radio Access Network (E-UTRAN), Universal Mobile Telecommunications System (UMTS), Global System for Mobile Communications (originally: Groupe Spécial Mobile) (GSM)/Enhanced Data rate for GSM Evolution (GSM/EDGE), Wideband Code Division Multiple Access (WCDMA), Time Division Multiple Access (TDMA) networks, Frequency Division Multiple Access (FDMA) networks, Orthogonal FDMA (OFDMA) networks, Single-Carrier FDMA (SC-FDMA) networks, Worldwide Interoperability for Microwave Access (WiMax), or Ultra Mobile Broadband (UMB), High Speed Packet Access (HSPA) Evolved Universal Terrestrial Radio Access (E-UTRA), Universal Terrestrial Radio Access (UTRA), GSM EDGE Radio Access Network (GERAN), 3GPP2 CDMA technologies, e.g., CDMA2000 1x RTT and High Rate Packet Data (HRPD), just to mention some few options.

The radio base station 534 may be referred to, respectively, as e.g., a base station, NodeB, evolved Node Bs (eNB, or eNode B), base transceiver station, Access Point Base Station, base station router, radio base station (RBS), micro base station, pico base station, femto base station, Home eNodeB, sensor, beacon device, relay node, repeater or any other network node configured for communication with the receiving device 520 over a wireless interface, depending, e.g., of the radio access technology and/or terminology used.

The receiving device 520 may correspondingly be represented by, e.g. a wireless communication terminal, a mobile cellular phone, a personal digital assistant (PDA), a wireless platform, a mobile station, a tablet computer, a portable communication device, a laptop, a computer, a wireless terminal acting as a relay, a relay node, a mobile relay, a customer premises equipment (CPE), a fixed wireless access (FWA) nodes or any other kind of device configured to communicate wirelessly with the radio network node, according to different embodiments and different vocabulary.

The terminology used in the detailed description of the embodiments as illustrated in the accompanying drawings is not intended to be limiting of the described scheduler 110, network device 120 and sending device 510, and the corresponding methods. These are instead limited by the enclosed claims.

1. A system for a communication network, the system comprising:
a processor; and
a memory coupled to the processor to store program code, which when executed by the processor, cause the processor to perform operations, the operations comprising:
receiving at least one predicted congestion level C_{pred} and at least one predicted radio channel quality Q_{pred} associated with a data flow; and
determining at least one of a transmission rate T_{R} or a data flow path T_{P} for transmission of the data flow based on the received predicted congestion level C_{pred} and the predicted radio channel quality Q_{pred}.

2. The system of claim 1, wherein the operations further comprise:
determining the transmission rate T_{R} or the data flow path T_{P} for a specified prediction time period, the prediction time period being specified by a subscription for the data flow.

3. The system of claim 1, wherein to the operations further comprise:
sending a subscription request S_{SR} to a network device, the subscription request S_{SR} including a request to send the predicted congestion level C_{pred} and the predicted radio channel quality Q_{pred} associated with the data flow for a specified prediction time period.

4. The system of claim 1, wherein receiving at least one predicted congestion level C_{pred} and at least one predicted radio channel quality Q_{pred} associated with the data flow comprises receiving predicted congestion levels C_{pred} and predicted radio channel quality values Q_{pred} for at least two prediction time periods.

5. A network device for a communication network, the network device comprising a processor configured to:
identify a data flow for at least one receiving device;
determine at least one predicted congestion level C_{pred} and at least one predicted radio channel quality Q_{pred} associated with the data flow; and
send the predicted congestion level C_{pred} and the predicted radio channel quality Q_{pred} to at least one scheduler.

6. The network device of claim 5, wherein the processor is further configured to receive a subscription request S_{SR} associated with the data flow, the subscription request S_{SR} including a request to send the predicted congestion level C_{pred} and the predicted radio channel quality Q_{pred} associated with the data flow to the at least one scheduler for a specified prediction time period.

7. The network device of claim 5, wherein the processor is further configured to:
receive a subscription request S_{SR} associated with the data flow, the subscription request S_{SR} including a flow identification information; and
identify the data flow and at least one node that provides information for prediction of the congestion level C_{pred} and the radio channel quality Q_{pred} associated with the data flow based on the received flow identification information.

8. The network device of claim 6, wherein the processor is further configured to compute and send the predicted congestion level C_{pred} and the predicted radio channel quality Q_{pred} for another prediction time period, the other prediction time period having a length being different from the specified prediction time period.

9. The network device of claim 5, wherein the processor is further configured to:
receive a transmission rate determined by at least one radio interface scheduler for transmission of the data flow over a radio interface; and
predict at least one of the congestion level C_{pred} and the radio channel quality Q_{pred} based also on the transmission rate determined by the at least one radio interface scheduler.

10. The network device as claimed in claim 5, wherein the processor is further configured to:
receive at least one of a measured congestion level Cₘₑₐₛ or a measured quality level Qₘₑₐₛ from at least one network node along a data flow path T_{P} for the data flow; and
predict at least one of the congestion level C_{pred} or the radio channel quality Q_{pred} based also on the at least one of the measured congestion level Cₘₑₐₛ or the measured quality level Qₘₑₐₛ.

11. The network device of claim 5, wherein to send the predicted congestion level C_{pred} and the predicted radio channel quality Q_{pred} to at least one scheduler, the processor is further configured to only send the predicted congestion level C_{pred} and the predicted radio channel quality Q_{pred} if the at least one scheduler is authenticated as subscribing to a service delivering the predicted congestion level C_{pred} and the predicted radio channel quality Q_{pred}.

12. A computer-implemented method for a communication network, the method comprising:
receiving at least one predicted congestion level C_{pred} and at least one predicted radio channel quality Q_{pred} associated with a data flow; and determining at least one of a transmission rate T_{R} or a data flow path T_{P} for transmission of the data flow based on the predicted congestion level C_{pred} and the predicted radio channel quality Q_{pred}.

13. A computer-implemented method for a communication network, the method comprising:
identifying a data flow for at least one receiving device;
determining at least one predicted congestion level C_{pred} and at least one predicted radio channel quality Q_{pred} associated with the data flow; and
sending the predicted congestion level C_{pred} and the predicted radio channel quality Q_{pred} to at least one scheduler.
